(19) United States
(12) Patent Application Publication
(10) Pub. No.: US 2017/0373480 A1
(43) Pub. Date: Dec. 28, 2017

(54) Electrical Connector

(71) Applicants: Tyco Electronics Japan G.K., Kanagawa (JP); Toyota Jidosha Kabushiki Kaisha, Aichi-ken (JP)

(72) Inventors: Tsugumi Matsumoto, Kanagawa (JP); Ryuichi Komiyama, Kanagawa (JP); Tomoyuki Funayama, Aichi-ken (JP)

(73) Assignees: Tyco Electronics Japan G.K., Kanagawa (JP); Toyota Jidosha Kabushiki Kaisha, Aichi-ken (JP)

(21) Appl. No.: 15/631,582

(22) Filed: Jun. 23, 2017

(30) Foreign Application Priority Data
Jun. 24, 2016 (JP) 2016-125746

(51) Int. Cl. H02G 3/08; H01R 13/639; H02G 3/10; H01R 13/52

(52) U.S. Cl. CPC H02G 3/088; H02G 3/105; H01R 13/6395; H01R 13/5221

(57) ABSTRACT

An electrical connector that prevents water from entering the hood of the electrical connector. The electrical connector includes a housing adapted to be mated in a receiving space in a hood of a mating connector. On a top side of the electrical connector in a state where the electrical connector is mated to the mating connector, the housing includes an inclined surface having an inclination angle of more than 90° at a front end of the hood of the mating connector for draining water falling onto the electrical connector.

### CROSS-REFERENCE TO RELATED APPLICATION

This application claims the benefit of the filing date under 35 U.S.C. §119(a)-(d) of Japanese Patent Application No. 2016-125746, filed Jun. 24, 2016.

### FIELD OF THE INVENTION

The present invention relates to an electrical connector and, more particularly, to an electrical connector having a light waterproof performance.

### BACKGROUND

In an electrical connector, a rubber seal ring that is separate from a housing is interposed between, for example, a male housing and a female housing, so as to prevent water from entering the electrical connector. The electrical connector, including this seal ring, is used at a location where water is more likely to enter.

In addition to the seal ring, a technique for providing a housing with an inclined surface, so as to discharge water which has entered a connector, has been proposed. For example, JP2011-150895A proposes a technique for forming an inclined surface on an inner surface of a case so that water which has entered a gap between the case and the connector can flow toward an opening side. JP2011-150895A discloses that a groove extending toward the opening side is formed in the inclined surface and drainage can be improved due to capillary action generated by the groove.

The inclined surface disclosed in JP2011-150895A is provided between a hood of the case and the connector so as to discharge the water which has entered the connector. However, the inclined surface cannot prevent the water from entering the connector. That is, it is understood that the structure disclosed in JP2011-150895A includes a seal ring, which allows water to enter until the water reaches the range of the seal ring.

The provision of the seal ring is advantages in terms of waterproofing, but has a problem that, for example, the number of parts increases. Accordingly, in the electrical connector that is placed at a position where water is less likely to fall, there is no need to provide a seal ring and it is sufficient to ensure a certain level of waterproofing or light waterproofing.

In general, water falls onto an upper part of an electrical connector in the vertical direction. Accordingly, the water received on the upper part of the electrical connector is highly likely to enter the gap between the hood and the connector.

### SUMMARY

An electrical connector, constructed in accordance with the present invention, is adapted to be mated in a receiving space formed in a hood of a mating connector. This electrical connector has a housing which has an upper wall, a bottom wall, and side walls. The upper wall has an inclined surface with an inclination angle of more than 90° and a stepped surface.

An electrical connector assembly, constructed in accordance with the present invention, includes a first electrical connector and a mating electrical connector. The first electrical connector has a housing which has an upper wall, a bottom wall, and side walls. The upper wall has an inclined surface with an inclination angle of more than 90° and a stepped surface. The mating electrical connector has a hood having a receiving space in which the housing of the first electrical connector is positioned with the inclined surface of the upper wall of the housing of the first connector outside the hood and the stepped surface of the upper wall of the housing of the first connector outside the hood and the stepped surface outside the hood.

### BRIEF DESCRIPTION OF THE DRAWINGS

FIG. 1A and FIG. 1B are perspective views of an electrical connector according to an embodiment of the present invention, FIG. 1A showing the electrical connector as viewed from a bottom side thereof and FIG. 1B showing the electrical connector as viewed from a top side thereof;

FIG. 2A and FIG. 2B are sectional views of the electrical connector according to the FIG. 1A and FIG. 1B embodiment, FIG. 2A being a longitudinal sectional view and FIG. 2B being a sectional view as viewed along a direction different from that in FIG. 2A;

FIG. 3A, FIG. 3B, and FIG. 3C are sectional diagrams useful in explaining a water stop function of the electrical connector according to the FIG. 1A and FIG. 1B embodiment, FIG. 3A showing an example in which an inclination angle θ is an obtuse angle, FIG. 3B showing an example in which the inclination angle θ is a right angle, and FIG. 3C showing an example in which the inclination angle θ is two right angles;

FIG. 4A and FIG. 4B are sectional views showing other examples of the electrical connector according to the FIG. 1A and FIG. 1B embodiment; and

FIG. 5A is a sectional view showing another example of the electrical connector according to the FIG. 1A and FIG. 1B embodiment and FIG. 5B is a sectional view showing still another example of the electrical connector according to the FIG. 1A and FIG. 1B embodiment.

### DETAILED DESCRIPTION OF THE PREFERRED EMBODIMENT(S)

Embodiments of the present invention will be described below with reference to the accompanying drawings.

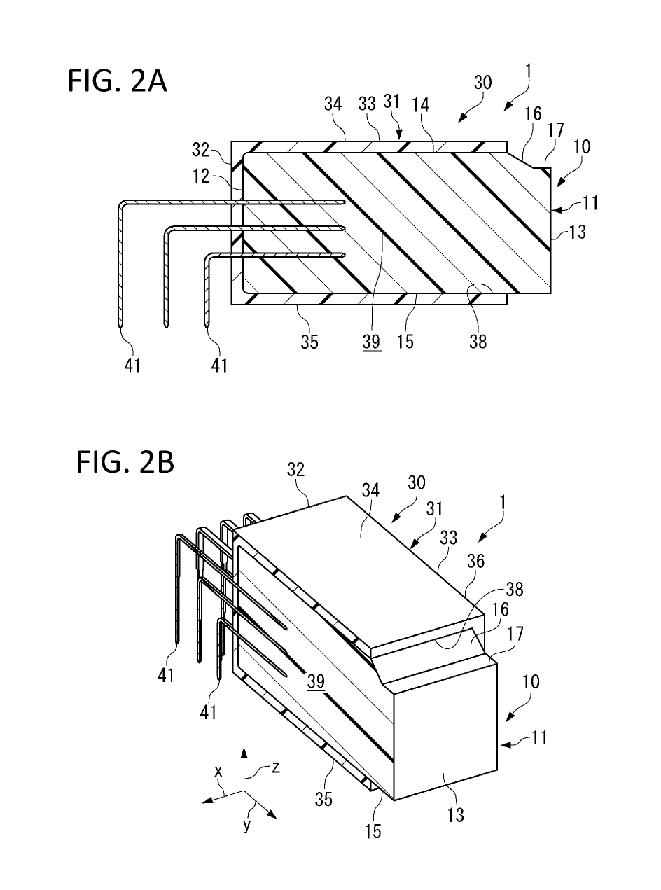

As shown in FIGS. 2A and 2B, an electrical connector 10 according to this embodiment of the present invention is fixed to, for example, a printed wiring board and is used in a state of an electrical connector assembly 1 in which the electrical connector 10 is mated with a mating connector 30. Note that the structures of the electrical connector 10 and the mating connector 30 are simplified for ease of explanation of a water stop function of this embodiment of the present invention.

### [Electrical Connector 10]

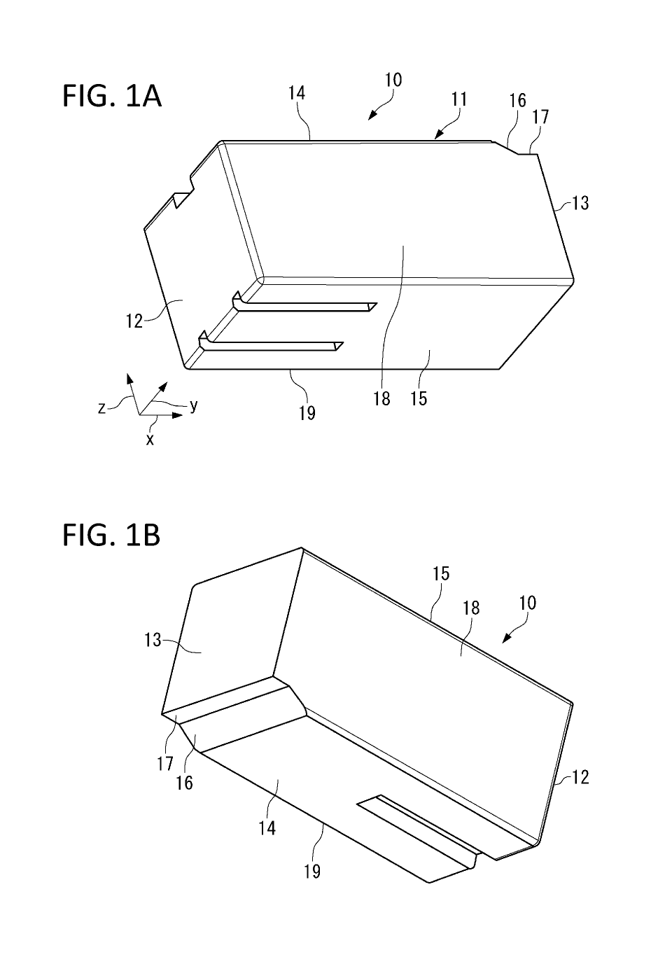

Referring to FIGS. 1A and 1B and FIGS. 2A and 2B, the electrical connector 10 includes a housing 11 and contacts. The housing 11 is integrally formed of resin having an electrical insulation. The contacts are formed of a material having high conductivity and elasticity, such as a copper-based material. Note that in FIGS. 1A and 1B and FIGS. 2A and 2B, the illustration of the contacts of the electrical connector 10 is omitted.

The housing 11 includes a front end wall 12 and a rear end 13. The front end wall 12 is first inserted when the electrical connector 10 is mated with the mating connector 30. The rear end 13 is opposed to the front end wall 12 and an electric wire connected to each contact is pulled out from the rear end 13. Holding holes, not illustrated, for accommodating and holding each contact and the like are provided between the front end wall 12 and the rear end 13. Note that in each of the electrical connector 10 and the mating connector 30, a side where the electrical connector 10 and the mating connector 30 are mated is defined as a front side and a side opposite to the front side is defined as a rear side.

The housing 11 includes an upper wall 14 and a lower wall 15. The upper wall 14 extends between the front end wall 12 and the rear end 13. The lower wall 15 extends between the front end wall 12 and the rear end 13 and is opposed in parallel to the upper wall 14. A part of the upper wall 14 at the rear end 13 has an inclined surface 16 and a stepped surface 17. When the upper wall 14 that is next to the inclined surface 16 is defined as a reference surface, the stepped surface 17 is below the reference surface and is in parallel to the reference surface. The housing 11 includes the inclined surface 16, which prevents water from entering a hood 33 of the mating connector 30 in a state where the electrical connector 10 is mated with the mating connector 30. This will be described later.

The housing 11 also includes a right side wall 18 and a left side wall 19. The right side wall 18 extends between the front end wall 12 and the rear end 13. The left side wall 19 extends between the front end wall 12 and the rear end 13 and extends opposite to and in parallel with the right side wall 18.

### [Mating Connector 30]

As shown in FIGS. 2A and 2B, the mating connector 30 includes a housing 31 and a plurality of contacts 41 held by the housing 31. The materials of the housing 31 and the contacts 41 are the same as those of the electrical connector 10.

The housing 31 includes a holding wall 32 which is at a rear end of the housing 31 and holds the plurality of contacts 41 in a state with the contacts 41 spaced apart. The housing 31 has a hood 33 which projects forward from the holding wall 32. The hood 33 has a rectangular tubular shape. A mating opening 38, which is an opening of the hood 33, has an end of the hood that is opposed to the holding wall 32. The hood 33 has a receiving space 39 which receives the electrical connector 10 and is between the holding wall 32 and the mating opening 38. The electrical connector 10 is inserted from the mating opening 38 into the receiving space 39.

As shown in FIGS. 2A and 2B, a part of each of the contacts 41 held by the holding wall 32 that is electrically connected to a contact of the electrical connector 10 extends into the receiving space 39 and another part of each of the contacts 41 that is connected to the printed wiring board (not shown) is pulled out backward from the holding wall 32. As shown in FIGS. 2A and 2B, the part of each of the contacts 41 that is pulled out backward is bent by 90 degrees in the middle of the contact. The contacts 41 are disposed in a plurality of columns in a width direction x and are disposed in a plurality of rows in a height direction z.

Note that in the electrical connector assembly 1 (the electrical connector 10 and the mating connector 30), a side of the electrical connector assembly that faces the printed wiring board to which the contacts 41 are connected is defined as a bottom side and a side of the electrical connector assembly that is opposite to the bottom side is defined as a top side. Accordingly, in FIGS. 1A and 1B and FIGS. 2A and 2B, the upper side of each of the mating connector 30 and the electrical connector 10 corresponds to the top side and the lower side thereof faces bottom side. Even when the orientation of the electrical connector assembly 1 is changed, the definition of the top side and the bottom side remains unchanged.

The hood 33 includes an upper wall 34, a lower wall 35, and a pair of side walls 36. The upper wall 34 and the lower wall 35 extend in the width direction x and are opposed to each other at a predetermined interval in the vertical direction. The pair of side walls 36 extends between, in the height direction z, both ends of each of the upper wall 34 and the lower wall 35 in the width direction x.

Note that in a usage state, in which the mating connector 30 is mated with the electrical connector 10, the mating connector 30 according to this embodiment of the present invention is disposed in such a manner that the height direction z matches the vertical direction, i.e., as shown in FIGS. 2A and 2B, and is connected to the printed wiring board, the illustration of which is omitted.

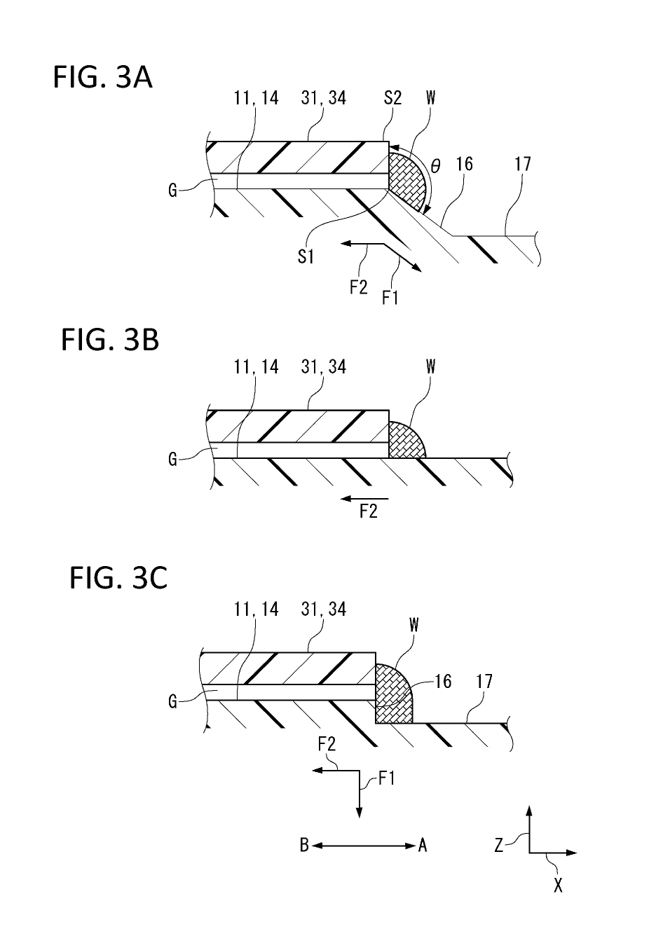

The water stop function obtained by providing the inclined surface 16 and the stepped surface 17 at the rear end of the upper wall 14 of the electrical connector 10 will be described with reference to FIGS. 3A to 3C. The water stop function works in the state in which the electrical connector 10 and the mating connector 30 are mated together as shown in FIGS. 2A and 2B. FIGS. 3A to 3C illustrate a rear part of the electrical connector 10 and a front end part of the mating connector 30.

FIGS. 3A to 3C are based on the premise that the water W falls onto a boundary between the rear part of the housing 11 of the electrical connector 10 and the front end part of the housing 31 of the mating connector 30 and the water W adheres to the boundary. In this case, since a gap G between the upper wall 14 of the housing 11 and the upper wall 34 of the mating connector 30 is narrow, the water W adhering to the boundary is likely to flow through the gap G toward the back of the housing 31, i.e., toward a front side B, due to the capillary action.

If the upper wall 14 of the electrical connector 10 forms a uniform flat surface and the gap G is not present, the water W tends to stay at the position. However, as shown in FIG. 3B, when the water W is in contact with the gap G, a force F2 toward the front side B of the gap G acts on the water W due to the capillary action, which causes the water to be drawn toward the front side B.

However, in the case of the embodiment shown in FIG. 3A, the inclined surface 16 is provided. With this structure, when the water W adhering to the boundary between the housing 11 and the housing 31 and the water W contacts the inclined surface 16, a resultant force F1 of a downward component and a component along the rear side A is generated on the water W, which causes the water W to flow along the inclined surface 16. The force F2 is also generated on the water W in the direction of the front side B due to the capillary action in the gap G. However, if the inclination angle θ of the inclined surface 16 is adjusted in such a manner that F1 is set to be larger than F2, the water W can be prevented from being drawn toward the front side B of the gap G. This is the water stop function of the present invention. The force F2 that causes the water W to enter the gap G can be reduced by increasing the contact angle of the water W that is physically in contact with the gap G.

In this embodiment, it is a minimum requirement that the inclination angle θ of the inclined surface 16 exceeds 90° so as to cause the force F1 including a component in a direction different from that of the force F2. The inclination angle θ is 180° (two right angles) at maximum. As the inclination angle θ increases, the contact angle of the water W increases, so that the water stop function for preventing the water W from flowing toward the front side B of the gap G is more likely to be fulfilled. The inclination angle θ is preferably 110° or more, more preferably 120° or more, and even more preferably 130° or more.

On the other hand, when the water stop effect due to gravity is taken into consideration, it is preferable to apply a force to the water W in a direction away from the gap G. As the inclination angle θ of the inclined surface 16 increases, the ratio of the space in the height direction z of the electrical connector 10 that is occupied by the inclined surface 16 increases, which inhibits downsizing of the housing 11 in the height direction z. In view of the above, it is necessary to suppress the inclination angle θ and the inclination angle θ is preferably 160° or less, more preferably 150° or less, and even more preferably 140° or less.

Most preferably, the inclination angle θ is in a range from 135° to 140°.

The present invention is not limited to the above embodiments. The structures illustrated in the above embodiments may be selected or omitted, or may be modified as appropriate to other structures without departing from the principle of the present invention.

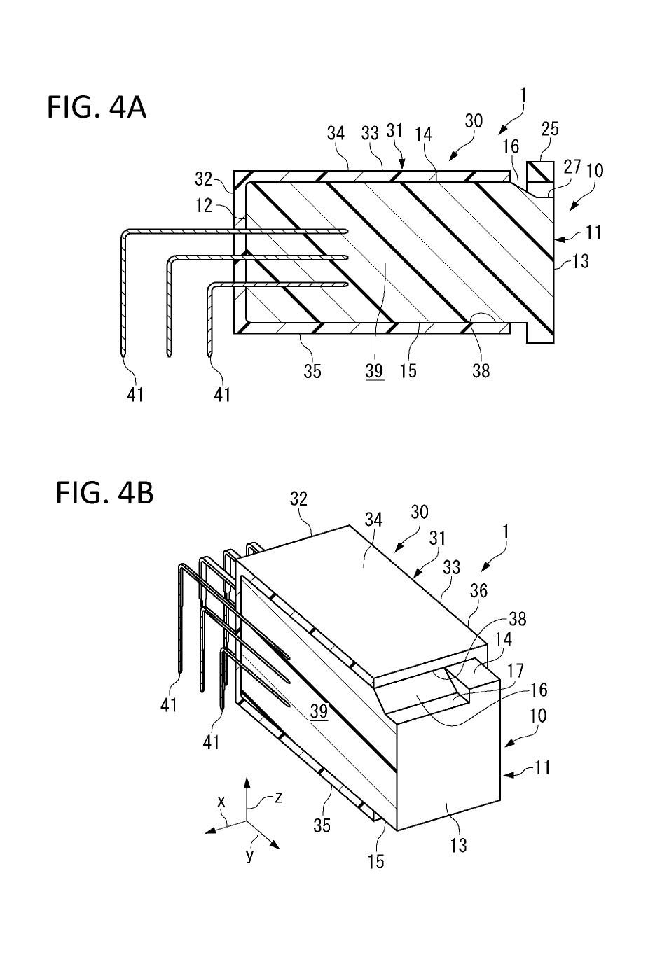

For example, as shown in FIG. 4A, when the electrical connector 10 includes a flange-like rear end wall 25 at a rear end of the electrical connector 10 and extends in the outer peripheral direction, it is preferable to have a drainage channel 27 which penetrates the rear end wall 25 so as to cause the water W flowing along the inclined surface 16 to further flow to the outside of the electrical connector. The drainage channel 27 may be continuous in the width direction x, or may be intermittent. It is preferable to have the drainage channel 27 in at least a region corresponding to a region in which the inclined surface 16 is located.

Further, the above embodiment illustrates an example of the electrical connector 10 in which the inclined surface 16 is in the entire region in the width direction x. However, the present invention is not limited to this example. For example, as shown in FIG. 4B, the inclined surface 16 may be only in a part of the region at a central part of the electrical connector 10 in the width direction x. Although not illustrated, the inclined surface 16 may be only in a part of the end of the electrical connector 10 in the width direction x, unlike in FIG. 4B. For example, the structure of the electrical connector 10 may make it difficult to have the inclined surface 16 in the entire region of the housing 11 in the width direction x. Further, if it is known that a region where water W falls down is limited, it is sufficient to have the inclined surface 16 only in a part of the region of the housing 11 corresponding to this region.

As shown in FIG. 3A, in the electrical connector 10 described above, a starting point S1 of the inclined surface 16 matches a front end position S2 of the hood 33 in a mating direction y. However, the present invention is not limited to this example.

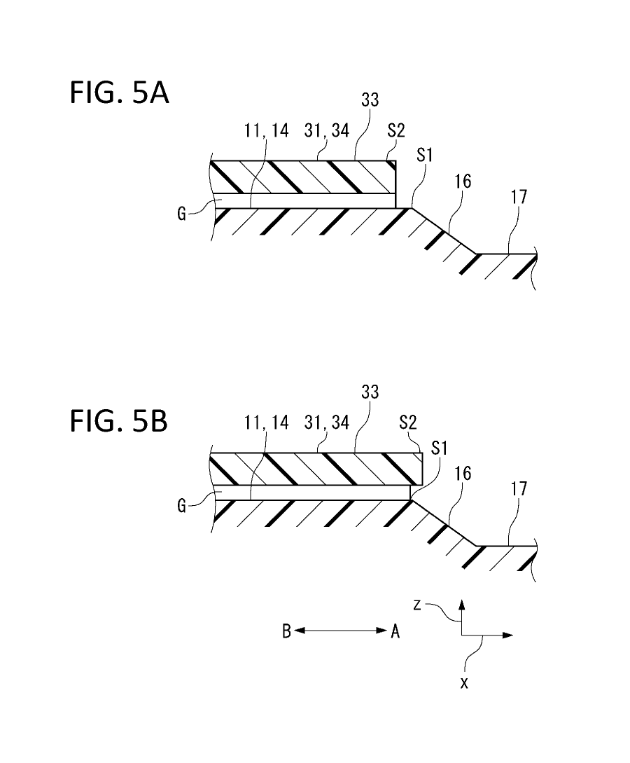

For example, as shown in FIG. 5A, even when the starting point S1 of the inclined surface 16 is shifted to the rear side A relative to the front end position S2 of the hood 33, the force F2 acts on the water W, so that the advantageous effects of the present invention can be achieved. On the contrary, as shown in FIG. 5B, even when the starting point S1 of the inclined surface 16 is shifted to the front side B relative to the front end position S2 of the hood 33, if the amount of shift is small, the force F2 acts on the water W, so that the advantageous effects of the present invention can be achieved. Thus, the present invention includes a mode in which the starting point S1 of the inclined surface 16 is different from the front end position S2 of the hood 33. However, according to the present invention, it is most preferable that the starting point S1 of the inclined surface 16 is in line with the front end position S2 of the hood 33 in the height direction.

Although the above embodiments are based on the premise that the top side of each of the electrical connector 10 and the mating connector 30 is directed upward in the vertical direction, the present invention is not limited to this example. The present invention is also effective when, for example, the mating direction y in which the electrical connector 10 and the mating connector 30 are mated together matches the vertical direction and a certain side of the inclined surface 16 is directed downward in the vertical direction.

What is claimed is:

1. An electrical connector comprising:
a housing configured to be mated to a receiving space formed in a hood of a mating connector, wherein
on a top side of the electrical connector in a usage state in which the electrical connector is mated with the mating connector, the housing includes an inclined surface having an inclination angle of more than 90° at a front end of the hood of the mating connector.

2. The electrical connector according to claim 1, wherein the housing includes the inclined surface in an entire region in a width direction of the housing, or in a part of the region.

3. The electrical connector according to claim 1, wherein the inclined surface has an inclination angle in a range from 110° to 160°.

4. The electrical connector according to claim 1, wherein the inclined surface has an inclination angle in a range from 135° to 140°.

5. The electrical connector according to claim 1, wherein
the housing comprises:
a flange-like rear end wall that is formed at a rear end of the housing in an outer peripheral direction of the housing; and
a drainage channel penetrating the rear end wall in a region of the rear end wall corresponding to the inclined surface.

6. The electrical connector according to claim 1, wherein a starting point of the inclined surface matches a front end position of the hood in a mating direction of the electrical connector and the mating connector.

7. The electrical connector according to claim 1, wherein a starting point of the inclined surface is shifted from a front end position of the hood.

8. An electrical connector:
adapted to be mated in a receiving space formed in a hood of a mating connector; and
having a housing which has:
(a) an upper wall having:
(1) an inclined surface with an inclination angle of more than 90°, and
(2) a stepped surface,
(b) a bottom wall, and
(c) side walls.

9. The electrical connector according to claim 8, wherein the inclined surface in the upper wall of the housing of the electrical connector extends across the entire with of the upper wall.

10. The electrical connector according to claim 9, wherein the inclined surface has an inclination angle in a range from 110° to 160°.

11. The electrical connector according to claim 9, wherein the inclined surface has an inclination angle in a range from 135° to 140°.

12. The electrical connector according to claim 8, wherein the housing of the electrical connector has:
(a) a peripheral flange fixed to and surrounding the stepped surface of the upper wall of the housing, and
(b) drainage channels extending from the inclined surface through the peripheral flange.

13. The electrical connector assembly comprising:
a first electrical connector having a housing which has:
(a) an upper wall having:
(1) an inclined surface with an inclination angle of more than 90°, and
(2) a stepped surface,
(b) a bottom wall, and
(c) side walls; and
a mating electrical connector having a hood having a receiving space in which the housing of the first electrical connector is positioned with the:
(a) inclined surface outside the hood, and
(b) stepped surface outside the hood.

14. The electrical connector assembly according to claim 13, wherein the inclined surface in the upper wall of the housing of the first electrical connector extends across the entire with of the upper wall.

15. The electrical connector according to claim 14, wherein the inclined surface has an inclination angle in a range from 110° to 160°.

16. The electrical connector according to claim 14, wherein the inclined surface has an inclination angle in a range from 135° to 140°.

17. The electrical connector according to claim 9, wherein the housing of the first electrical connector has:
(a) a peripheral flange fixed to and surrounding the stepped surface of the upper wall of the housing, and
(b) drainage channels extending from the inclined surface through the peripheral flange.
